(19) United States
(12) Patent Application Publication
(10) Pub. No.: US 2020/0219224 A1
(43) Pub. Date: Jul. 9, 2020

(54) COMPUTER-READABLE RECORDING MEDIUM HAVING STORED THEREIN PROGRAM FOR DETERMINING FPGA IMPLEMENTATION, METHOD FOR DETERMINING FPGA IMPLEMENTATION, AND INFORMATION PROCESSING APPARATUS

(71) Applicant: FUJITSU LIMITED, Kawasaki-shi (JP)

(72) Inventor: Shizuko Maruyama, Yokohama (JP)

(73) Assignee: FUJITSU LIMITED, Kawasaki-shi (JP)

(21) Appl. No.: 16/690,315

(22) Filed: Nov. 21, 2019

(30) Foreign Application Priority Data
Jan. 7, 2019 (JP) 2019-000766

(51) Int. Cl. G06T 1/20; G06T 1/60; G06F 15/78

(52) U.S. Cl. CPC G06T 1/20; G06T 2200/28; G06F 15/7803; G06T 1/60

(57) ABSTRACT

A recording medium stores a program for a process including: receiving operation information for determining whether to perform offload from a first integrated circuit to a second integrated circuit; performing first judgment of determining that the offload is possible when resolution is equal to or higher than a threshold; performing second judgment of determining that the offload is possible when it is determined in accordance with the operation information that access to a memory included in the second integrated circuit is continuous in the operation; performing third judgment of determining that the offload is possible when it is determined in accordance with the operation information that the operation is able to be performed in a parallelized manner; and performing determination processing of determining whether the offload is possible in accordance with a judgment by the first judgment, a judgment by the second judgment, and a judgment by the third judgment.

### CROSS-REFERENCE TO RELATED APPLICATION

This application is based upon and claims the benefit of priority of the prior Japanese Patent Application No. 2019-766, filed on Jan. 7, 2019, the entire contents of which are incorporated herein by reference.

### FIELD

The embodiment discussed herein is related to a computer-readable recording medium having stored therein a program for determining FPGA implementation, a method for determining FPGA implementation, and an information processing apparatus.

### BACKGROUND

After the density of integrated circuit has been increased for many years, integrated circuits are recently approaching the physical limitation predicted in Moore's law. In consideration of the physical limitation of integrated circuit, part of processing performed by a computer processing unit (CPU) is implemented as hardware by using a field-programmable gate array (FPGA) so that the system control is improved.

For example, a known technology is that a function to be implemented by using an FPGA is determined by analyzing a source program and accordingly judging whether desired performance is achieved when the function is implemented as hardware by using an FPGA.

Examples of the related art include Japanese Laid-open Patent Publication Nos. 2005-63136 and 2017-111572.

### SUMMARY

According to an aspect of the embodiments, a non-transitory computer-readable recording medium stores therein a program for causing a computer to execute a process which is for determining FPGA implementation and includes: receiving operation information for determining whether to perform offload processing from a first integrated circuit of a fixed circuit configuration to a second integrated circuit of a programmable circuit configuration; performing first judgment processing of determining that the offload processing is possible when resolution is equal to or higher than a threshold of suitability for the offload processing, the resolution being of an image targeted for an operation and being obtained from the operation information; performing second judgment processing of determining that the offload processing is possible when it is determined in accordance with the operation information that access to a memory included in the second integrated circuit is continuous in the operation; performing third judgment processing of determining that the offload processing is possible when it is determined in accordance with the operation information that the operation is able to be performed in a parallelized manner; and performing determination processing of determining whether the offload processing is possible or impossible in accordance with a combination of a positive or negative judgment obtained in the first judgment processing, a positive or negative judgment obtained in the second judgment processing, and a positive or negative judgment obtained in the third judgment processing and outputting a determination result to a storage section.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are a diagram for explaining performance before and after FPGA offload;

FIGS. 2A and 2B are diagrams for explaining the case in which performance is not improved by FPGA offload;

FIG. 3 is a diagram for explaining the relationship between resolution and performance;

FIG. 4 is a diagram for explaining the relationship between the existence or nonexistence of random access and performance;

FIG. 5 is a diagram for explaining the relationship between the number of operations for one image and performance;

FIG. 6 is a diagram for explaining the case in which it is possible to perform parallelization or pipelining for multiple operations;

FIG. 7 is a diagram for explaining the case in which it is impossible to perform parallelization or pipelining for multiple operations;

FIG. 8 illustrates an example of a network configuration according to this embodiment;

FIG. 9 illustrates an example of a hardware configuration of an information processing apparatus;

FIG. 10 illustrates an example of a hardware configuration of a terminal;

FIG. 11 illustrates an example of a configuration of functions of the information processing apparatus;

FIG. 12 is a diagram for explaining processing for judging FPGA implementation that is performed by an FPGA implementation determination section;

FIGS. 13A and 13B are a flowchart for illustrating first judgment processing performed by a first judgment unit;

FIG. 14 is a flowchart for illustrating second judgment processing performed by a second judgment unit;

FIG. 15 is a flowchart for illustrating third judgment processing performed by a third judgment unit;

FIG. 16 illustrates an example of an input screen for judging FPGA implementation;

FIG. 17 illustrates an example of a data configuration of a performance DB;

FIG. 18 illustrates an example of a data configuration of a correspondence table;

FIG. 19 illustrates an example of a data configuration of a message table;

FIG. 20 is a diagram for explaining processing for generating a reply by a reply generating unit; and

FIG. 21 illustrates an example of a determination result screen.

### DESCRIPTION OF EMBODIMENTS

In the above-described technology for analyzing a source program that is run by a CPU and accordingly determining a function to be implemented as hardware by using an FPGA (hereinafter referred to as “FPGA offload”), characteristics of data targeted for processing is not considered. As a result, when FPGA offload processing is carried out, performance is not necessarily improved.

This is because FPGA offload is suitable or unsuitable depending on the application (processing details) and there is no index for determining the suitability. Developers thus repeat tests (for example, for two to three months), and as a result of long-term tests, in some cases, it is determined that FPGA offload is unsuitable.

Therefore, in one aspect, determination of whether operation for a processing target is suitable for FPGA offload may be facilitated.

Hereinafter, an embodiment of the present disclosure is described with reference to the drawings. Firstly, FPGA offload, which is to implement part of processing performed by a computer processing unit (CPU) as hardware by using a field-programmable gate array (FPGA), is described. In the following description, FPGA offload is simply referred to as “FPGA implementation” in some cases.

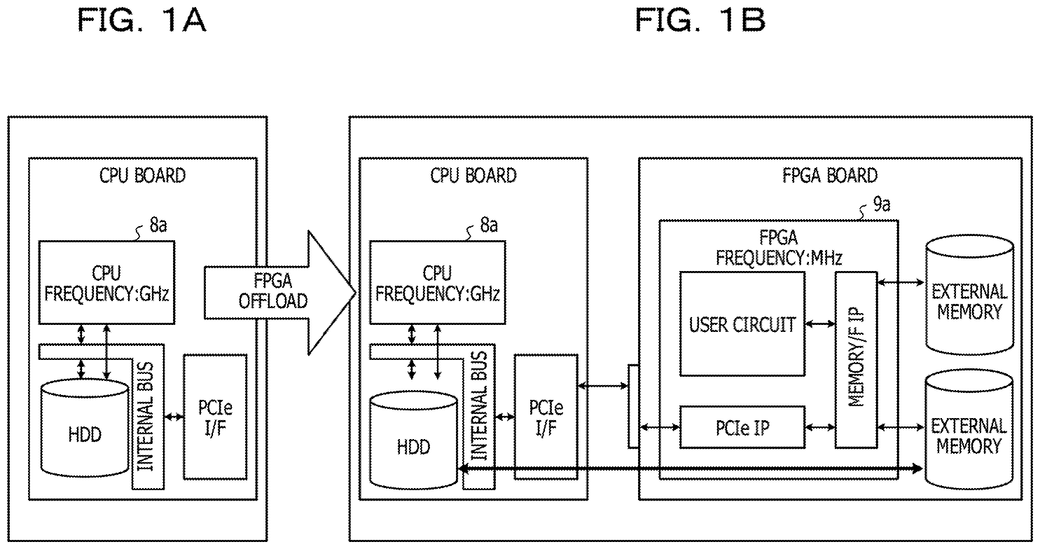

FIGS. 1A and 1B are a diagram for explaining performance before and after FPGA offload. FIG. 1A illustrates an example of a configuration including only a CPU before FPGA offload while FIG. 1B illustrates an example of a configuration including the CPU and an FPGA after FPGA offload.

In FIG. 1A, since it is before FPGA offload, a single CPU 8a performs all processing. Thus, in this case, the processing time of the single CPU 8a is targeted for performance evaluation. In FIG. 1B, since the CPU causes an FPGA 9a to perform part of processing, data transfer occurs between the CPU 8a and the FPGA. Whereas processing load of the CPU 8a decreases, the processing time of the FPGA 9a is spent in addition to the processing time of the CPU 8a. Thus, in this case, the total time of the processing time of the CPU 8a, the processing time of the FPGA 9a, and the time for data transfer is targeted for performance evaluation.

As described above, when the configuration is the one before FPGA offload, evaluation target processing time=CPU processing time.

The evaluation target processing time before FPGA offload is hereinafter referred to as a “first processing time”. When the configuration is the one after FPGA offload, evaluation target processing time=CPU processing time+FPGA processing time+data transfer time.

The evaluation target processing time after FPGA offload is hereinafter referred to as a “second processing time”.

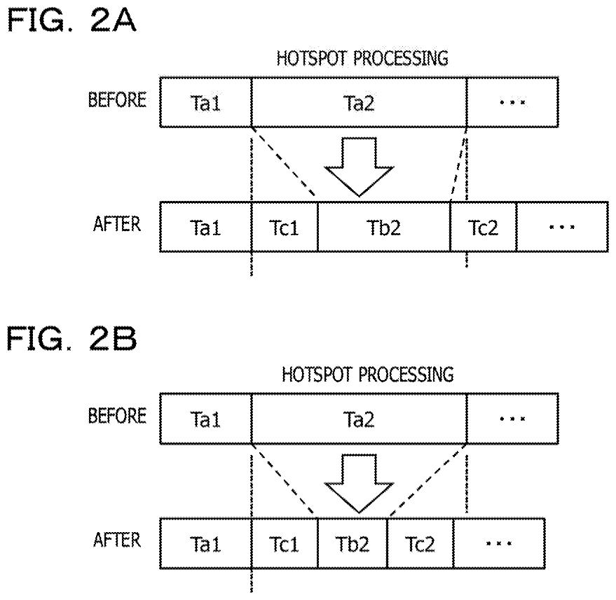

When after FPGA offload the second processing time is not reduced as compared to the first processing time (first processing time>second processing time), it is pointless to implement processing as hardware by using an FPGA. The time for performing processing by using an FPGA (hereinafter referred to as “hotspot processing”) is further described with reference to FIGS. 2A and 2B.

FIGS. 2A and 2B are diagrams for explaining the case in which performance is not improved by FPGA offload. In FIGS. 2A and 2B, respective processing times denote as follows: a processing time Ta1 denotes the processing time of the CPU 8a for processing 1; a processing time Tat denotes the processing time of the CPU 8a for processing 2 that is hotspot processing determined as a target for FPGA offload; a processing time Tc1 denotes a time for transferring data to be processed by the FPGA 9a from a hard disk drive (HDD) of the CPU 8a to an external memory; a processing time Tc2 denotes a time for transferring data (processing result) from an internal memory of the FPGA 9a to the HDD of the CPU 8a via the external memory; and a processing time Tb2 denotes a time for processing the processing 2 (hotspot processing) by the FPGA.

In both FIGS. 2A and 2B, the upper one indicates a processing time in the case of performing the processing 1 and the processing 2 by using the CPU before FPGA offload and the lower one indicates a processing time of performing the processing 1 by using the CPU 8a and the processing 2 by using the FPGA 9a after FPGA offload.

In FIG. 2A, the processing time in the case of performing both the processing 1 and the processing 2 by using the CPU 8a is shorter than the processing time after FPGA offload (first processing time<second processing time). In this case, FPGA offload of the processing 2 (hotspot processing) is not desired.

In FIG. 2B, the processing time in the case of offloading the processing 2 to the FPGA is shorter than the processing time in the case of performing both the processing 1 and the processing 2 by using the CPU (first processing time>second processing time). In this case, FPGA offload of the processing 2 (hotspot processing) is desired.

As described above, in the case in which the processing time for the processing 2 (hotspot processing) by the FPGA 9a is shorter than the processing time by the CPU 8a, when the processing time for data transfer is additionally taken into consideration, the hotspot processing is not necessarily suitable for FPGA offload.

The inventors examined FPGA offload as described below with regard to image processing, which is generally considered to be desirable as a target for FPGA offload, and found a technique for easily determining the suitability for FPGA offload.

The examinations conducted by the inventors are about the relationship between resolution and performance, the relationship between the existence or nonexistence of random access and performance, the relationship between the number of operations for one image and performance, and the relationship between parallelization or pipelining and performance in consideration of the possibility of performing parallelization or pipelining. The examinations are individually described below.

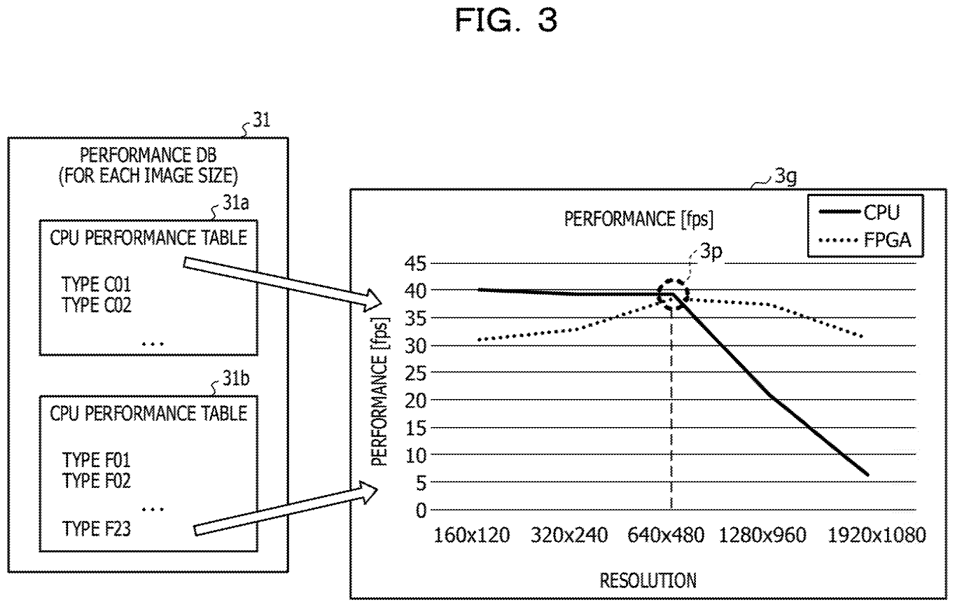

FIG. 3 is a diagram for explaining the relationship between resolution and performance. FIG. 3 illustrates an example of a graph 3g depicting, with respect to different resolutions, the performance of a CPU of a type selected by a designer and the performance of an FPGA of a type selected by the designer in accordance with a performance database (DB) 31 constructed for different resolutions.

In the graph 3g, the horizontal axis indicates resolution and the vertical axis indicates performance (frame per second (fps)). According to the graph 3g, while the resolution is “160×120”, “320×240”, and “640×480”, the performance of the CPU stably remains at a high level, specifically 40 fps; after the resolution exceeds “640×480”, the performance decreases and reaches approximately the half when the resolution is “1280×960”; and when the resolution is “1920×1080”, the performance decreases to 80% of the performance at the time when the resolution is “640×480”. The performance of the FPGA of the selected type remains at levels equal to or higher than 30 fps with respect to any resolutions.

When the two kinds of performances are compared to each other, in the case in which the resolution is equal to or higher than “640×480”, the performance of the CPU is higher than the performance of the FPGA; in the case in which the resolution is “640×480”, the performance of the CPU is equal to the performance of the FPGA; and in the case in which the resolution is higher than “640×480”, the performance of the FPGA is higher than the performance of the CPU. Accordingly, the resolution“640×480” is the turning point at which the performance of the CPU and the performance of the FPGA are reversed. When the combination of the CPU and the FPGA is used, it tells that, in the case in which the resolution is equal to or lower than “640×480”, FPGA offload is unsuitable; when the resolution is higher than “640×480”, FPGA offload is suitable. As described above, resolution is the important factor for judgment regarding FPGA offload.

A performance reversing point 3p indicating a resolution with respect to which the performances are reversed as described above varies depending on the combination of the type of CPU and the type of FPGA. The inventors focused on the performance reversing point 3p and found a technique in which the performance reversing point 3p is obtained by referring to the performance DB 31 indicating the performance of a selected type with respect to different resolutions and the performance reversing point 3p is used as a threshold for judging suitability for FPGA offload.

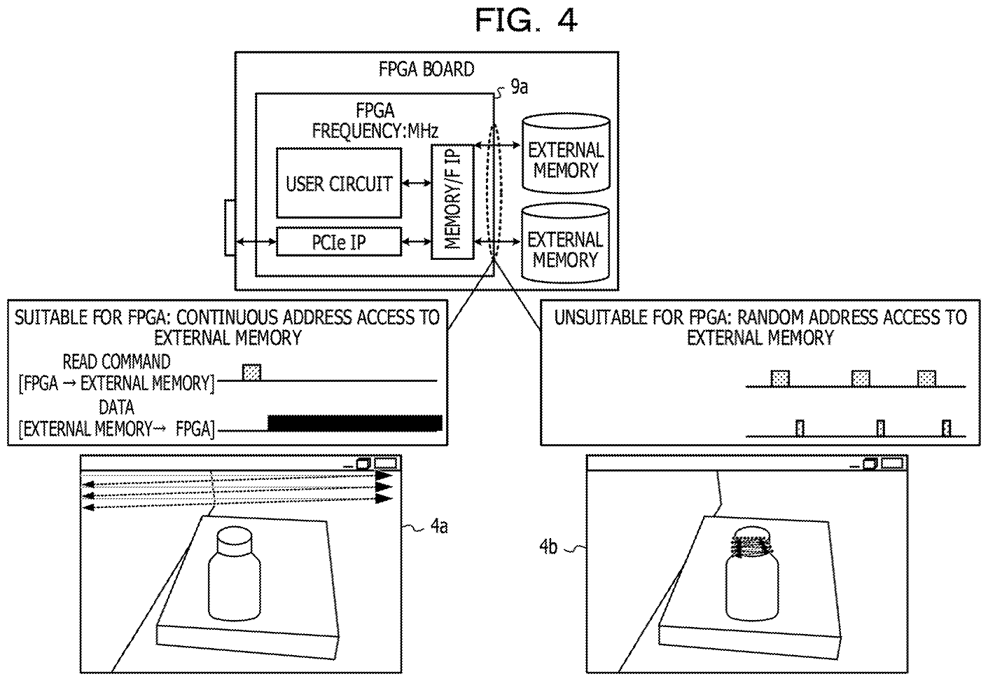

FIG. 4 is a diagram for explaining the relationship between the existence or nonexistence of random access and performance. FIG. 4 describes suitability for FPGA by using the case of transferring data of an original image 4a and the case of transferring data of an image 4b formed by adding a drawing such as a line, a character, or a character to the original image 4a.

When the FPGA reads the original image 4a, by executing a read command for the external memory only one time, continuous data is transferred at one time from the external memory to the FPGA. This means that it is possible to carry out continuous address access and a large amount of data is transferred by executing one command, and thus, efficient data transfer is achieved. Such continuous address access is suitable for FPGA.

In contrast, since the image 4b is read by way of random access, transferring a small amount of data by executing one command is repeated. Such random access is unsuitable for FPGA.

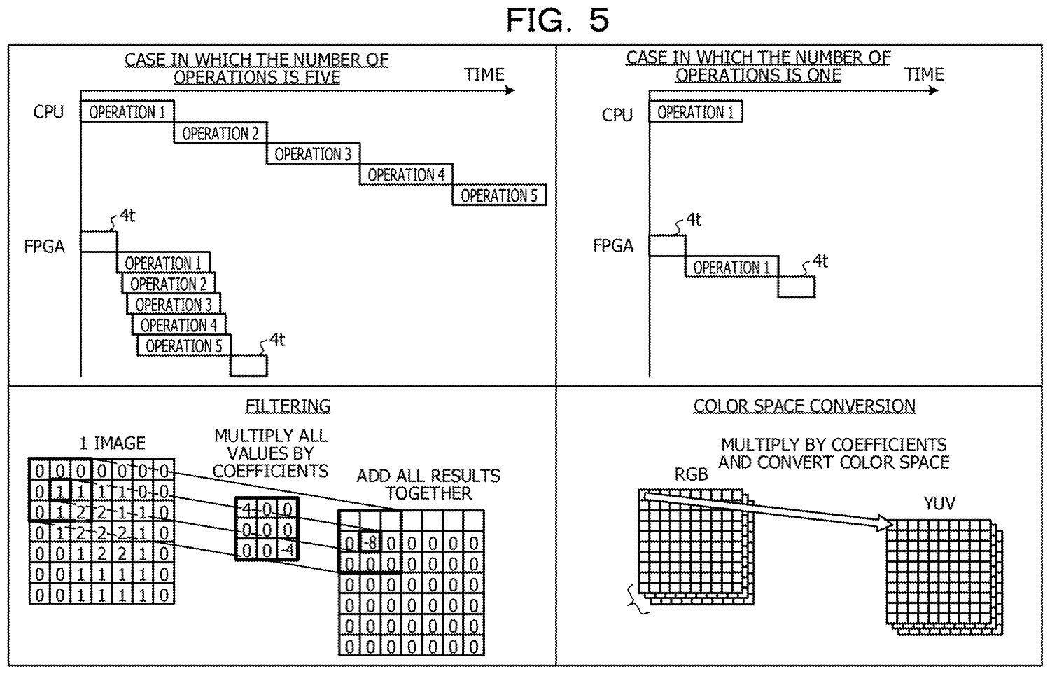

FIG. 5 is a diagram for explaining the relationship between the number of operations for one image and performance. FIG. 5 illustrates the comparison between the case of performing multiple operations for one image and the case of performing one operation for one image. As one example, the case of performing multiple operations is described by using filtering and the case of performing one operation is described by using color space conversion. In this embodiment, the number of operations denotes the number of different processing operations.

In the case of filtering, values corresponding to the size of a filter are successively obtained from pixel values by sliding the filter one by one from the upper left of an image, all the values are multiplied by coefficients, and as a result, the sum of the values is obtained as the result of an area corresponding to the filter. This series of processing operations are performed by multiple operations (for example, an operation 1, an operation 2, an operation 3, an operation 4, and an operation 5).

Since the CPU performs filtering by way of serial processing, the operation 1 is performed for one entire image; and after the operation 1 is completed, the operation 2 is performed. Subsequently, the operations 3, 4, and 5 are performed in the same manner. Thus, the total of the processing time from the operations 1 to 5 indicates performance.

In contrast, since the FPGA successively performs the operations 1 to 5 with respect to each area unit corresponding to the filter, it is not desired that the operation 2 waits for the completion of processing of the operation 1 for one entire image. Processing for one entire image is carried out by repeating the operations 1 to 5 with respect to each area unit of the filter. In this case, when a data transfer time 4t is additionally taken into consideration, the total time for filtering by using the FPGA is still shorter than the total time for filtering by using the CPU. This means that offloading filtering to the FPGA enables improvement of performance by way of parallelization or pipelining.

Next, color space conversion is considered as an example in the case in which the number of operations is one. Color space conversion is to multiply pixels of a red (R) image, a green (G) image, and a black (B) image, which represent one image of RGB, by coefficients and convert the image of RGB into an image of YUV, which is indicated by three elements of a luminance signal (Y), a blue color component differential signal (U), and a red color component differential signal (V).

Since color space conversion is performed by way of serial processing, color space conversion is suitable for processing by the CPU. In contrast, when processing is offloaded to the FPGA, the processing time for data transfer is added, and thus, it is difficult to shorten the time in comparison to the processing time by using the CPU. When the number of operations for one entire image is relatively small, the time for data transfer is dominant and it is difficult to improve performance. Accordingly, the possibility of FPGA offload is determined in accordance with whether there are two or more operations.

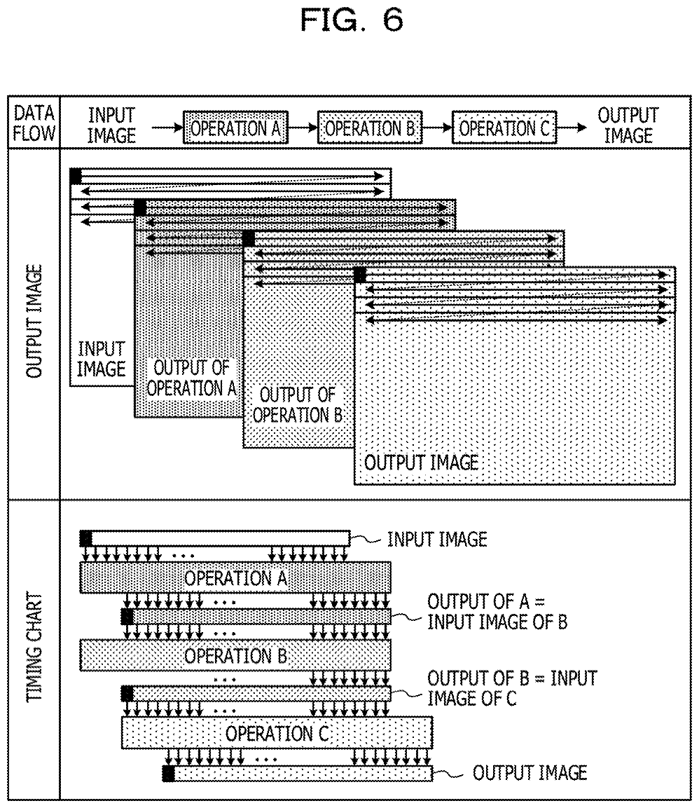

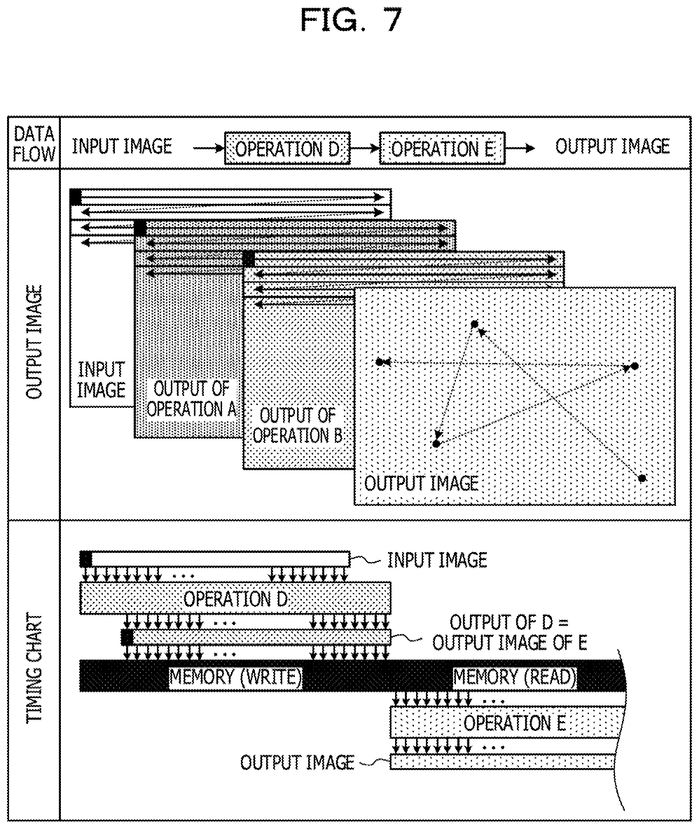

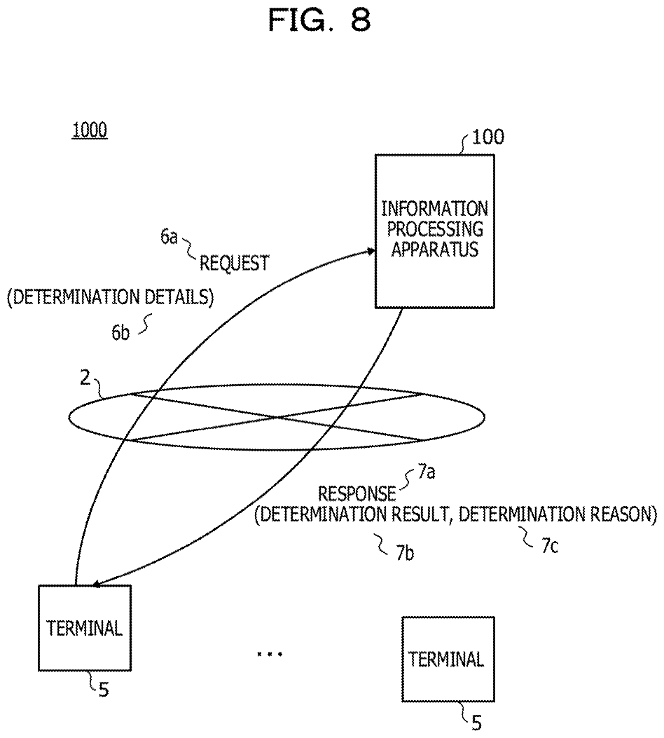

However, when multiple operations are performed, depending on the possibility of parallelization or pipelining, FPGA offload is suitable or unsuitable. The relationship between parallelization or pipelining and performance in consideration of the possibility of performing parallelization or pipelining is described with reference to FIGS. 6 and 7.

FIG. 6 is a diagram for explaining the case in which it is possible to perform parallelization or pipelining for multiple operations. FIG. 6 indicates, as indicated by a data flow, the case in which operations A, B, and C are performed for one image (input image) and accordingly an output image is obtained as the result.

According to the output image and a timing chart, when it is possible to perform parallelization or pipelining, in other words, when it is possible to perform the operations A, B, and C while the input image is scanned in a given direction, the output of the operation A is used in the subsequent stage, that is, the operation B, and then the output of the operation B is used in the subsequent stage, that is, the operation C.

FIG. 7 is a diagram for explaining the case in which it is impossible to perform parallelization or pipelining for multiple operations. FIG. 7 indicates, as indicated by a data flow, the case in which operations D and E are performed for one image (input image) and accordingly an output image is obtained as the result.

According to the output image and a timing chart, since in the operation E processing is performed by way of random access, it is desired to wait for the completion of processing of the operation D for the entire input image. Specifically, the processing result of the one image is written in memory, and then, the data is obtained by randomly accessing the memory and processed in the operation E. In the example in FIG. 7, because random access is performed in the operation E, it is impossible to perform parallelization or pipelining.

An example of a network configuration for performing determination for FPGA implementation that is to determine suitability (suitable/unsuitable) of FPGA offload in accordance with the examinations described above is described with reference to FIG. 8. FIG. 8 illustrates an example of a network configuration according to this embodiment. In a system 1000 illustrated in FIG. 8, it is possible to couple an information processing apparatus 100 and one or more terminals 5 to each other via a network 2.

The information processing apparatus 100 receives from the terminal 5 a request 6a for inquiring the determination of FPGA offload and sends to the terminal 5 a reply 7a containing a determination result 7b and a determination reason 7c regarding suitability for FPGA offload in accordance with a determination details 6b of the request 6a.

The request 6a contains the determination details 6b including information for determining FPGA offload. The reply 7a contains the determination result 7b indicating that FPGA offload is suitable or unsuitable and the determination reason 7c for the determination details 6b.

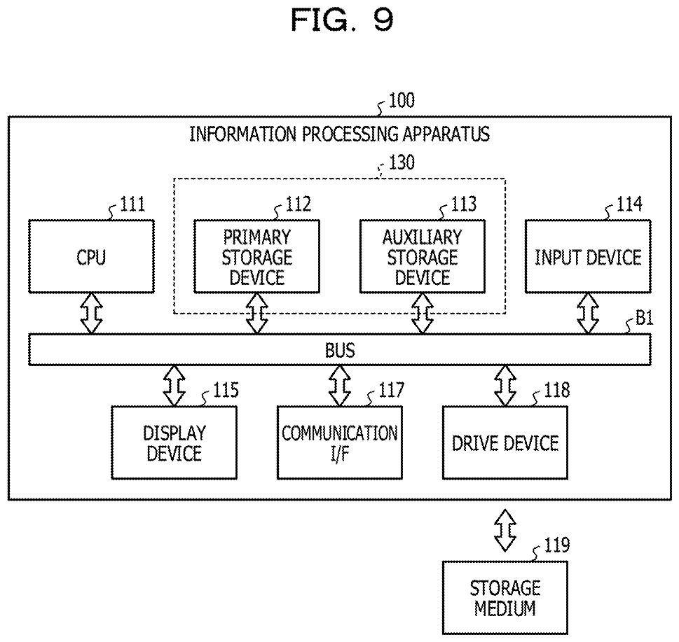

FIG. 9 illustrates an example of a hardware configuration of an information processing apparatus. According to FIG. 9, the information processing apparatus 100 includes a CPU 111, a primary storage device 112, an auxiliary storage device 113, an input device 114, a display device 115, a communication interface (I/F) 117, and a drive device 118, which are coupled to a bus B1. The auxiliary storage device 113, the input device 114, and an external storage device that the information processing apparatus 100 is able to access are collectively referred to as a storage section 130.

The CPU 111 corresponds to a processor that controls the information processing apparatus 100 and implements various kinds of processing according to this embodiment that will be described later by running a program stored in the storage section 130. The display device 115 is controlled by a user operating the input device 114 to display various screens.

The program for determining FPGA implementation that is according to this embodiment and stored in a storage medium 119 (for example, a compact disc read-only memory (CD-ROM)) is installed into the storage section 130 via the drive device 118, so that the program is able to be run by the CPU 111.

The storage medium 119 storing the program for determining FPGA implementation according to this embodiment is not limited to a CD-ROM and may be at least one non-transitory tangible medium that is computer-readable and forms a structure. As the computer-readable storage medium, other than a CD-ROM, a portable storage medium, such as a digital versatile disk (DVD) or a Universal Serial Bus (USB) flash drive, or a semiconductor memory, such as a flash memory, may be used.

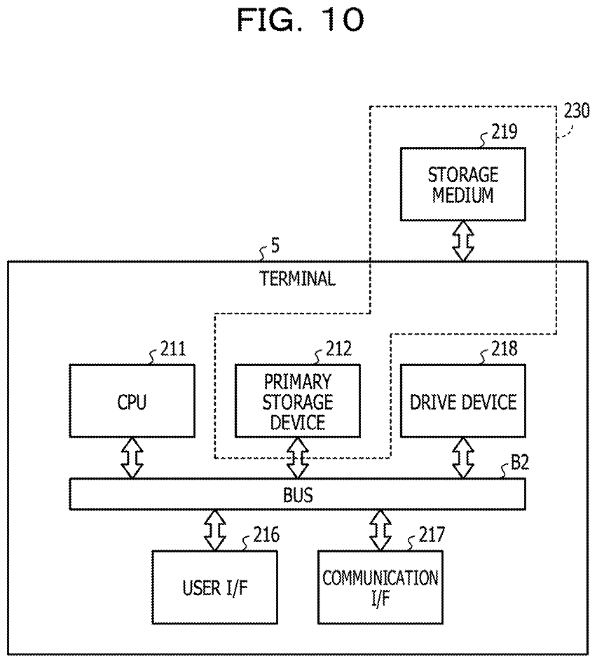

FIG. 10 illustrates an example of a hardware configuration of a terminal. According to FIG. 10, the terminal 5 is an information processing terminal that is controlled by a computer, such as a tablet computer or a cellular phone, and includes a CPU 211, a primary storage device 212, a user I/F 216, a communication I/F 217, and a drive device 218, which are coupled to a bus B2. The primary storage device 212, a storage medium 219, and the like are referred to as a storage section 230.

The CPU 211 corresponds to a processor that controls the terminal 5 and implements various kinds of processing according to this embodiment that will be described later by running a program stored in the storage section 230. The user I/F 216 is, for example, a touch panel that displays various kinds of information under the control of the CPU 211 and that is capable of receiving operational inputs by a user. Communication by using the communication I/F 217 is not limited to wireless or wired communication.

The terminal 5 may be an information processing terminal of, for example, a desktop type, a notebook type, or a laptop type. The hardware configuration of the terminal 5 is the same as the hardware configuration in FIG. 9 and the description thereof is thus omitted.

This embodiment is not limited to the network configuration in FIG. 8. The function of the information processing apparatus 100 may be implemented by each of the terminals 5 and the terminal 5 may perform by itself processing for judging FPGA implementation that is according to this embodiment and described later.

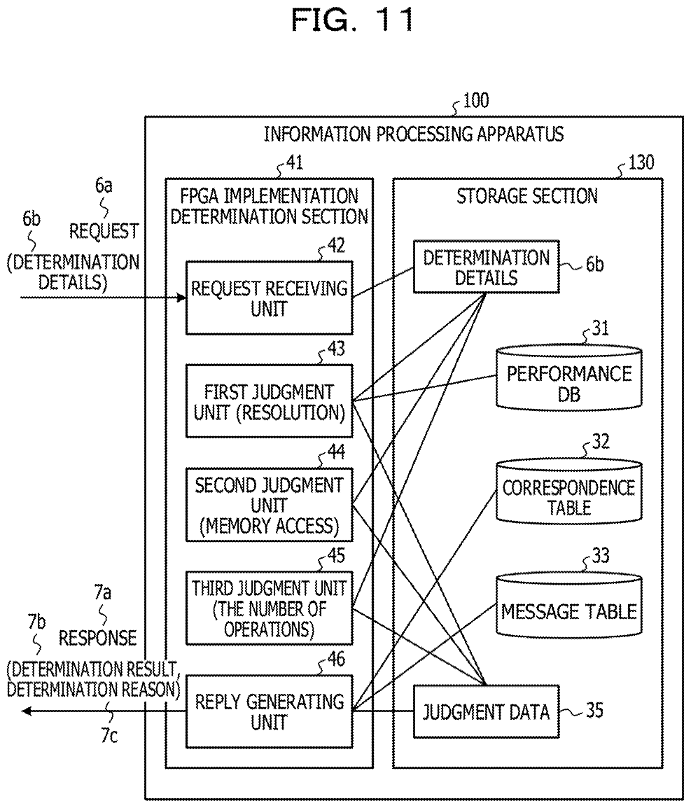

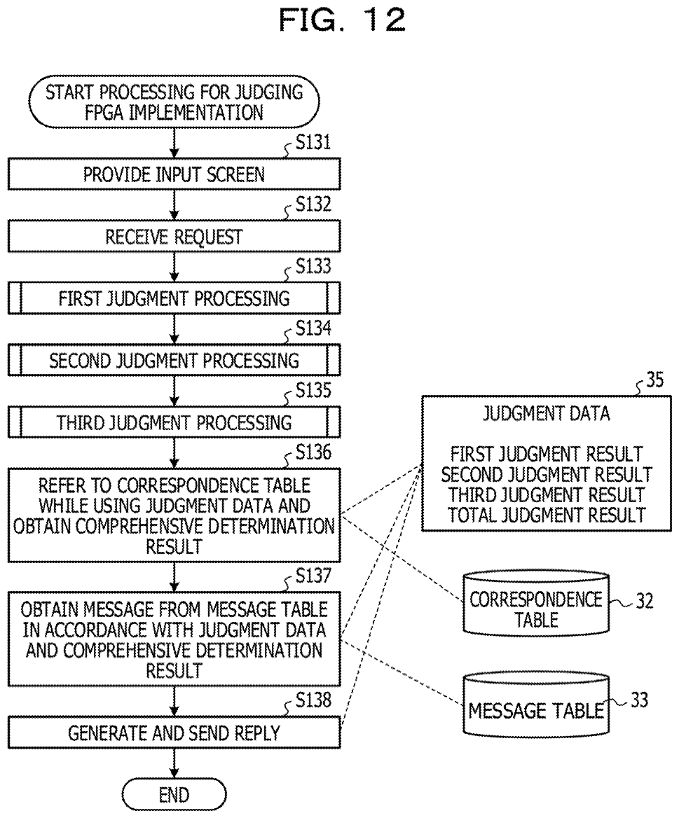

FIG. 11 illustrates an example of a logical configuration of functions of the information processing apparatus. According to FIG. 11, the information processing apparatus 100 mainly includes an FPGA implementation determination section 41. The storage section 130 stores, for example, the determination details 6b, the performance DB 31, a correspondence table 32, a message table 33, and judgment data 35.

The FPGA implementation determination section 41 is implemented such that, in response to the request 6a received via the network 2, processing for determining suitability for FPGA in accordance with the determination details 6b of the request 6a is performed and the CPU 111 runs the program for determining FPGA implementation.

The FPGA implementation determination section 41 includes, as processing units, a request receiving unit 42, a first judgment unit 43, a second judgment unit 44, a third judgment unit 45, and a reply generating unit 46. The processing units 42 to 46 are implemented by the CPU 111 running programs corresponding to the respective processing units.

When the request 6a sent by the terminals 5 is received via the communication I/F 117, the request receiving unit 42 stores in the storage section 130 the determination details 6b contained in the request 6a.

The first judgment unit 43 obtains from the determination details 6b a CPU type, an FPGA type, and an image size, refers to the performance DB 31, obtains a first threshold that is a criterion for judging FPGA implementation, and consequently obtains a first judgment result by comparing the obtained first threshold and the image size of the determination details 6b. The first judgment result is recorded in the judgment data 35. The image size indicates resolution (the number of pixels) and represents the amount of data.

The second judgment unit 44 obtains the status of memory access from the determination details 6b, obtains a second judgment result by judging suitability for FPGA implementation, and records the second judgment result in the judgment data 35. The third judgment unit 45 obtains the number of operations from the determination details 6b, obtains a third judgment result by judging suitability for FPGA implementation, and records the second judgment result in the judgment data 35.

After the processing operations performed by the first judgment unit 43, the second judgment unit 44, and the third judgment unit 45 are completed, the reply generating unit 46 obtains a comprehensive determination result from the correspondence table 32 by using the judgment data 35. The reply generating unit 46 then obtains, by using the judgment data 35, from the message table 33 messages corresponding to the first judgment result, the second judgment result, and the third judgment result, generates the reply 7a containing the obtained messages and the comprehensive determination result, and sends the reply 7a to the terminal 5. The generated reply 7a contains the determination result 7b representing the comprehensive determination result and the determination reason 7c representing the messages corresponding to the first judgment result, the second judgment result, and the third judgment result.

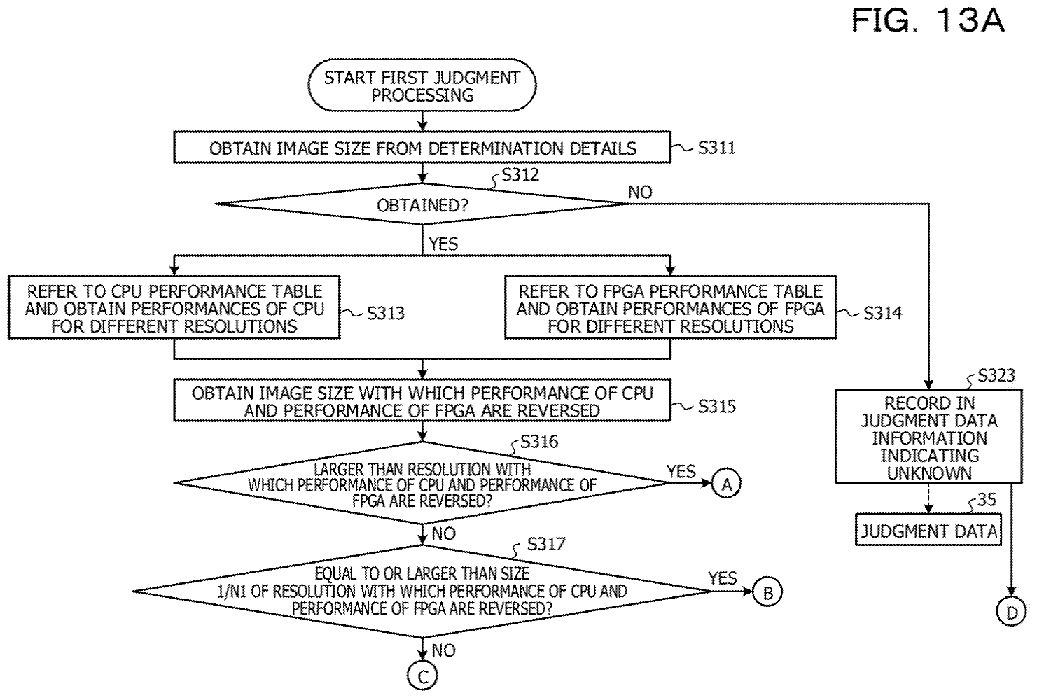

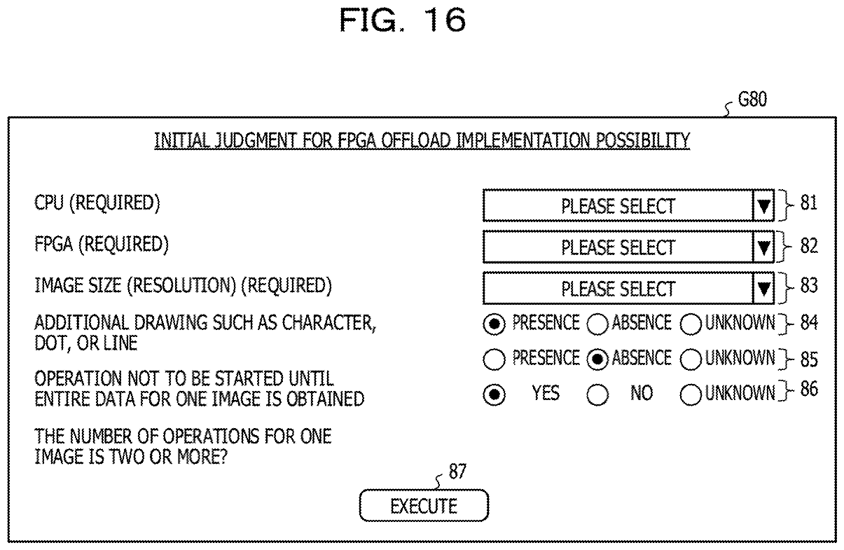

Next, various kinds of processing that are according to this embodiment and performed by the information processing apparatus 100 are described in detail. FIG. 12 is a diagram for explaining the processing for judging FPGA implementation that is performed by the FPGA implementation determination section. According to FIG. 12, the FPGA implementation determination section 41 provides, in response to a request for obtaining a screen, the request being sent by the terminals 5, an input screen G80 (FIG. 16) for judging FPGA implementation for the terminals 5 (step S131).

The communication I/F 117 of the information processing apparatus 100 receives the request 6a from the terminals 5 via the network 2 and the determination details 6b contained in the request 6a received by the request receiving unit 42 is stored in the storage section 130 (step S132).

Subsequently, judgment processing operations are performed by the first judgment unit 43, the second judgment unit 44, and the third judgment unit 45. The order of the judgment processing operations is not limited to the order of step S in a flowchart in FIG. 12. The judgment processing operations may be performed in any order. Here, as one example, the order starting with first judgment processing, followed by second judgment processing and third judgment processing is used in the description.

The first judgment unit 43 performs the first judgment processing (step S133) and the first judgment result is recorded in the judgment data 35. The second judgment unit 44 performs the second judgment processing (step S134) and the second judgment result is recorded in the judgment data 35. The third judgment unit 45 performs the third judgment processing (step S135) and the third judgment result is recorded in the judgment data 35.

After the first judgment result, the second judgment result, and the third judgment result are recorded in the judgment data 35, the reply generating unit 46 obtains the comprehensive determination result by referring to the correspondence table 32 with the use of the judgment data 35 (step S136). The comprehensive determination result is recorded in the judgment data 35.

The reply generating unit 46 obtains messages from the message table 33 by using the judgment data 35 (step S137). The reply generating unit 46 obtains messages corresponding to the first judgment result, the second judgment result, the third judgment result, and the comprehensive determination result.

The reply generating unit 46 then generates the reply 7a containing the obtained four messages and sends the reply 7a to the terminal 5 (step S138). The reply 7a contains the determination result 7b representing the comprehensive determination result and the determination reason 7c composed of three messages corresponding to the first judgment result, the second judgment result, and the third judgment result.

With the completion of sending the reply 7a, the FPGA implementation determination section 41 ends the processing for judging FPGA implementation.

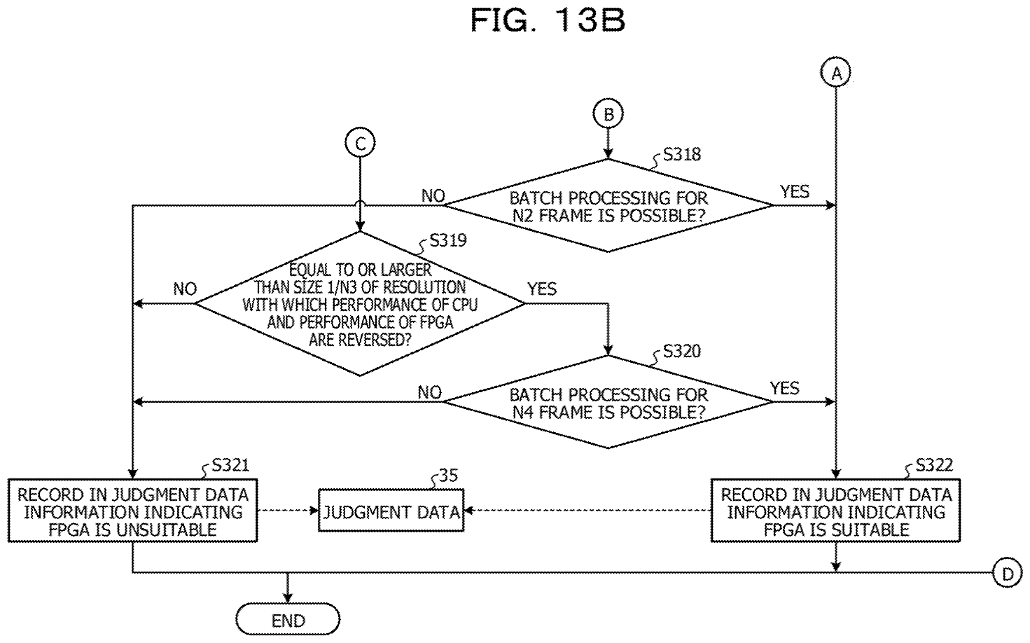

FIGS. 13A and 13B are a flowchart for illustrating the first judgment processing performed by the first judgment unit. In FIGS. 13A and 13B, N1, N2, N3, and N4 are preset thresholds (positive values), where N1<N3, and N2<N4.

In FIGS. 13A and 13B, the first judgment unit 43 obtains the image size from the determination details 6b in the storage section 130 (step S311). Subsequently, the first judgment unit 43 determines whether the image size is obtained (step S312). When the image size is not obtained (NO in step S312), the first judgment unit 43 records information representing unknown as the judgment result for the image size in the judgment data 35 (step S323) and the first judgment unit 43 then ends the first judgment processing.

By contrast, when the image size is obtained (YES in step S312), the first judgment unit 43 refers to a CPU performance table 31a of the performance DB 31 and obtains performances with respect to different resolutions of the CPU of the type designated in the determination details 6b (step S313). The first judgment unit 43 also refers to an FPGA performance table 31b of the performance DB 31 and obtains performances with respect to different resolutions of the FPGA of the type designated in the determination details 6b (step S314). The order of the processing in step S313 and the processing in step S314 is not limited to this example. The order may be reversed.

The first judgment unit 43 obtains a particular resolution with respect to which the performance of the CPU and the performance of the FPGA are reversed (step S315). The particular resolution with which the performance of the FPGA rises above the performance of the CPU may be specified by comparing the performance of the CPU and the performance of the FPGA with respect to each resolution. The specified resolution corresponds to the performance reversing point 3p as illustrated in FIG. 3.

The first judgment unit 43 then determines whether the image size obtained from the determination details 6b is larger than the size corresponding to the resolution with which the performance of the CPU and the performance of the FPGA are reversed (step S316). When the image size is larger than the size corresponding to the resolution (YES in step S316), the first judgment unit 43 records in the judgment data 35 information indicating that the corresponding processing is suitable for FPGA (step S322) and the first judgment unit 43 ends the first judgment processing.

By contrast, when the image size obtained from the determination details 6b is equal to or smaller than the size corresponding to the resolution with which the performance of the CPU and the performance of the FPGA are reversed (NO in step S316), the first judgment unit 43 determines, with respect to the resolution with which the performance of the CPU and the performance of the FPGA are reversed, whether the image size obtained from the determination details 6b is equal to or larger than a size 1/N1 (step S317). When the image size is smaller than the size 1/N1 (NO in step S317), the first judgment unit 43 proceeds to step S319.

By contrast, when the image size is equal to or larger than the size 1/N1 (YES in step S317), the first judgment unit 43 determines whether it is possible to perform batch processing for an N2 frame by using the FPGA of the type designated in the determination details 6b (step S318). When it is possible to perform batch processing for the N2 frame (YES in step S318), the first judgment unit 43 records in the judgment data 35 information indicating that the corresponding processing is suitable for FPGA (step S322) and the first judgment unit 43 ends the first judgment processing.

When it is impossible to perform batch processing for the N2 frame (NO in step S318), the first judgment unit 43 further determines whether the image size of the determination details 6b is equal to or larger than a size 1/N3 corresponding to the resolution with which the performance of the CPU and the performance of the FPGA are reversed (step S319). When the image size is smaller than the size 1/N3 (NO in step S319), the first judgment unit 43 records in the judgment data 35 information indicating that the corresponding processing is unsuitable for FPGA (step S321) and the first judgment unit 43 ends the first judgment processing.

When the image size is equal to or larger than the size 1/N3 (YES in step S319), the first judgment unit 43 determines whether it is possible to perform batch processing for a N4 frame (step S320). When it is possible to perform batch processing for the N4 frame (YES in step S320), the first judgment unit 43 records in the judgment data 35 information indicating that the corresponding processing is suitable for FPGA (step S322) and the first judgment unit 43 ends the first judgment processing.

When it is possible to perform batch processing for the N4 frame (NO in step S320), the first judgment unit 43 records in the judgment data 35 information indicating that the corresponding processing is unsuitable for FPGA (step S321) and the first judgment unit 43 ends the first judgment processing.

As described above, in this embodiment, when the resolution is lower than the resolution with which the performance of the CPU and the performance of the FPGA are reversed, it is possible to accurately judge the suitability for FPGA implementation in accordance with whether it is determined, with respect to respective frames, that batch processing is possible.

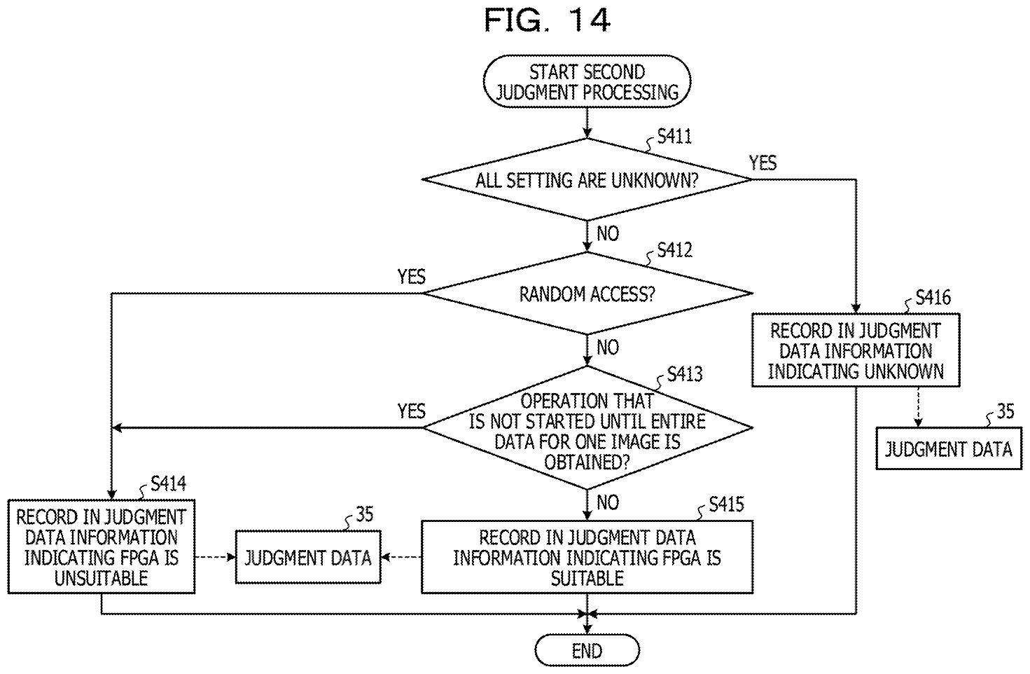

FIG. 14 is a flowchart for illustrating the second judgment processing performed by the second judgment unit. In FIG. 14, the second judgment unit 44 refers to the determination details 6b in the storage section 130 and determines whether all items regarding memory access are set as unknown (step S411). When not all items are set as unknown (NO in step S411), the second judgment unit 44 performs processing described below. When the processing described below is performed, in the determination details 6b, an item regarding memory access may indicate not “YES (memory access is performed)” or “NO (memory access is not performed)” but “UNKNOWN”. In this case, the processing is performed in accordance with another item indicating “YES” or “NO” other than “UNKNOWN”.

The second judgment unit 44 refers to the determination details 6b and determines whether random access is performed (step S412). When the setting regarding additional drawing indicates “YES”, it is determined that random access is performed. When random access is performed (YES in step S412), the second judgment unit 44 records in the judgment data 35 information indicating that the corresponding processing is unsuitable for FPGA (step S414) and the second judgment unit 44 ends the second judgment processing.

When random access is not performed (or when whether random access is performed is unknown) (NO in step S412), the second judgment unit 44 further determines whether there is a particular operation that is not started until entire data for one image is obtained (step S413). When there is a particular operation that is not started until entire data for one image is obtained (YES in step S413), the second judgment unit 44 records in the judgment data 35 information indicating that the corresponding processing is unsuitable for FPGA (step S414) and the second judgment unit 44 ends the second judgment processing.

By contrast, when there is no operation that is not started until entire data for one image is obtained (or when whether there is such an operation is unknown) (NO in step S413), the second judgment unit 44 records in the judgment data 35 information indicating that the corresponding processing is suitable for FPGA (step S415) and the second judgment unit 44 ends the second judgment processing.

When all settings are unknown (YES in step S411), the second judgment unit 44 records in the judgment data 35 information indicating unknown (step S416) and the second judgment unit 44 ends the second judgment processing.

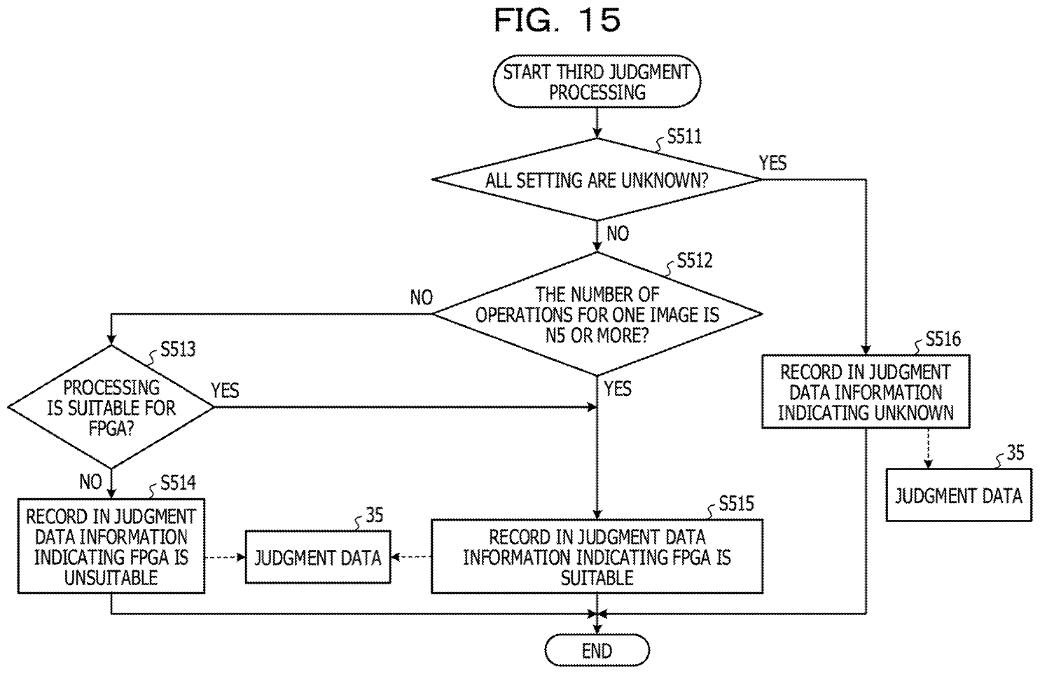

FIG. 15 is a flowchart for illustrating the third judgment processing performed by the third judgment unit. In FIG. 15, N5 denotes a preset threshold (positive value). In FIG. 15, the third judgment unit 45 refers to the determination details 6b in the storage section 130 and determines whether all items regarding operation are set as unknown (step S511). When not all items are set as unknown (NO in step S511), the third judgment unit 45 performs processing described below. When the processing described below is performed, in the determination details 6b, an item regarding operation may indicate not “YES (memory access is performed)” or “NO (memory access is not performed)” but “UNKNOWN”. In this case, the processing is performed in accordance with another item indicating “YES” or “NO” other than “UNKNOWN”.

It is determined whether the number of operations for one image is equal to or more than N5 (step S512). The number of operations for one image is equal to or more than N5 (YES in step S512), the third judgment unit 45 determines that it is possible to perform parallel processing, records in the judgment data 35 information indicating that the corresponding processing is suitable for FPGA (step S515), and consequently ends the third judgment processing.

When the number of operations for one image is less than N5 (or when whether the number of operations for one image is equal to or more than N5 is unknown) (NO in step S512), the third judgment unit 45 further determines whether the corresponding processing is suitable for FPGA (step S513). For example, it is checked whether the determination details 6b indicate that an additional drawing such as a character, a dot, or a line exists. When the setting about the existence or nonexistence of an additional drawing in the determination details 6b is referred to and the setting regarding additional drawing indicates “YES”, it is determined that the corresponding processing is unsuitable for FPGA; when the setting indicates that no additional drawing exists, it is determined that the corresponding processing is suitable for FPGA.

When it is determined that the corresponding processing is unsuitable for FPGA (or when whether the corresponding processing is suitable for FPGA is unknown) (NO in step S513), the third judgment unit 45 records in the judgment data 35 information indicating that the corresponding processing is unsuitable for FPGA (step S514) and the third judgment unit 45 ends the third judgment processing. When the third judgment unit 45 determines that the corresponding processing is suitable for FPGA (YES in step S513), the third judgment unit 45 records in the judgment data 35 information indicating that the corresponding processing is suitable for FPGA (step S515) and the third judgment unit 45 ends the third judgment processing.

When all settings are unknown (YES in step S511), the third judgment unit 45 records in the judgment data 35 information indicating unknown (step S516) and the third judgment unit 45 ends the third judgment processing.

FIG. 16 illustrates an example of an input screen for judging FPGA implementation. The input screen G80 for judging FPGA implementation illustrated in FIG. 16 is a screen displayed at the user I/F 216 of the terminal 5 and has setting areas 81 to 86 and an execute button 87.

The setting area 81 is an area for selecting a CPU type, the setting area 82 is an area for selecting a FPGA type, and the setting area 83 is an area for selecting an image size (resolution). The setting area 84 is an area for setting the existence or nonexistence of an additional drawing such as a character, a dot, or a line, the setting area 85 is an area for setting existence or nonexistence of an operation that is not started until entire data for one image is obtained, and the setting area 86 is an area for setting whether the number of operations for one image is two or more.

While the setting areas 81 to 83 are required to be set, the setting areas 84 to 86 are allowed to be set as “UNKNOWN” in addition to “YES” and “NO”. With this configuration, when input image data is unknown, judging the possibility of FPGA offload is practicable to some extent, and as a result, it is possible to improve the convenience for users (for example, software developers) who do not have enough knowledge and experiences regarding hardware.

When a user selects the execute button 87 after completing setting, the request 6a is sent to the information processing apparatus 100. By selecting the execute button 87, the determination details 6b representing set values that are set by the user is included in the request 6a and the request 6a is sent.

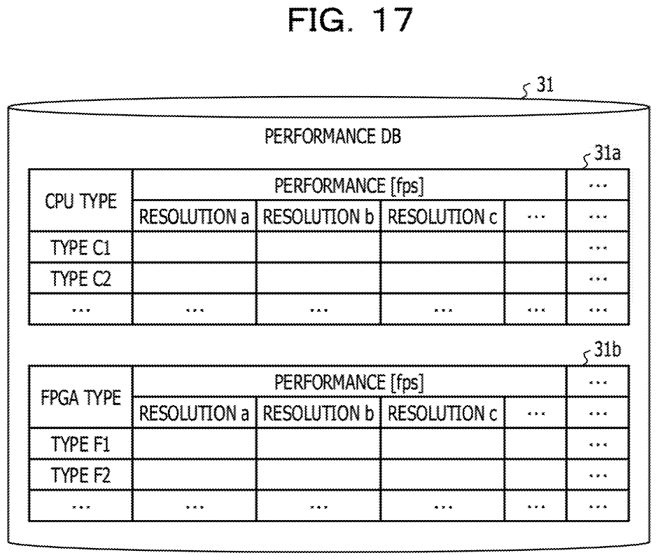

FIG. 17 illustrates an example of a data configuration of the performance DB. In FIG. 17, the performance DB 31 includes the CPU performance table 31a and the FPGA performance table 31b.

The CPU performance table 31a is a table indicating, with respect to each CPU type, for example, the performances corresponding to different resolutions and includes fields such as the CPU type and resolution. The CPU type field indicates a product name that is used for specifying the type of CPU. In the setting area 81 of the input screen G80 (FIG. 16), a list of CPU types contained in the CPU performance table 31a are displayed as options.

The resolution field includes a plurality of resolutions (the number of pixels) as subfields and indicates the performance (fps) for each resolution. For example, the performances are indicated with respect to, for example, quarter video graphics array (QVGA), half video graphics array (HVGA), video graphics array (VGA), high definition (HD), full high definition (full HD), and 4K.

The FPGA performance table 31b is a table indicating, with respect to each CPU type, for example, the performances corresponding to different resolutions and includes fields such as the FPGA type and resolution. The FPGA type field indicates a product name that is used for specifying the type of FPGA. In the setting area 82 of the input screen G80 (FIG. 16), a list of FPGA types contained in the FPGA performance table 31b are displayed as options. The resolution field includes a plurality of resolutions (the number of pixels) as subfields and indicates the performance (fps) for each resolution.

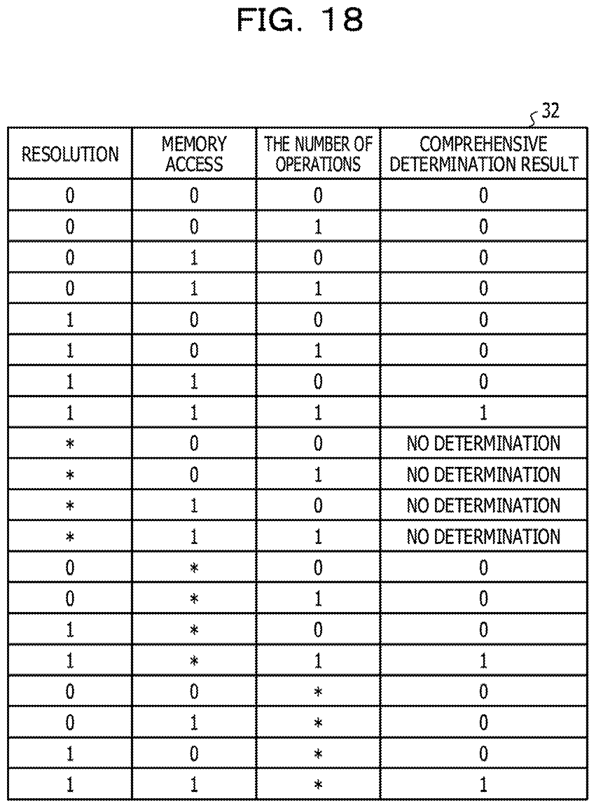

FIG. 18 illustrates an example of a data configuration of the correspondence table. The correspondence table 32 illustrated in FIG. 18 is a table indicating a comprehensive determination result concerning FPGA offload for each of the combinations of judgment results obtained by the first judgment unit 43, the second judgment unit 44, and the third judgment unit 45. The correspondence table 32 includes fields such as resolution, memory access, the number of operations, and comprehensive determination result.

The resolution field indicates a judgment result obtained by the first judgment unit 43. The memory access field indicates a judgment result obtained by the second judgment unit 44. The number of operation field indicates a judgment result obtained by the third judgment unit 45. In these three fields, the status in which FPGA is unsuitable is represented by “0”, the status in which FPGA is suitable is represented by “1”, and the status in which the suitability for FPGA is unknown is represented by “*”.

The comprehensive determination result field indicates a judgment result for a combination of the judgment result of resolution, the judgment result of memory access, and the judgment result of the number of operations. The status in which FPGA is unsuitable is represented by “0”, the status in which FPGA is suitable is represented by “1”, and the status in which it is impossible to judge the suitability or unsuitability “no determination”.

According to the correspondence table 32, when the resolution field, the memory access field, and the number of operations field all indicate the status in which FPGA is suitable, when the memory access field indicates unknown and the other two fields indicate the status in which FPGA is suitable, or when only the number of operations field indicates unknown and the other two fields indicate the status in which FPGA is suitable, the comprehensive determination result indicates that FPGA is suitable. When the resolution field indicates unknown, in the case in which the other two fields indicate that FPGA is suitable or unsuitable, the comprehensive determination result indicates “no determination”.

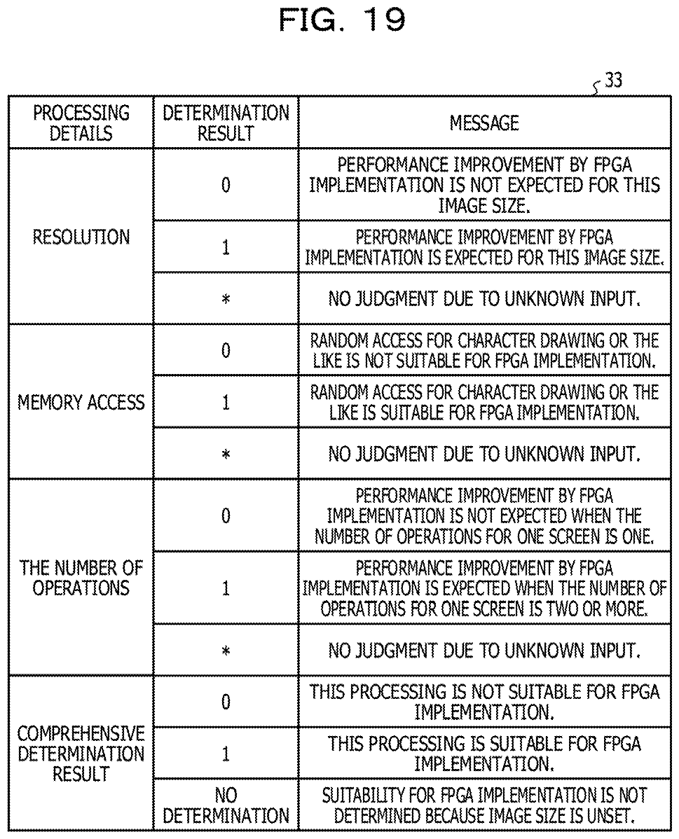

FIG. 19 illustrates an example of a data configuration of the message table. The message table 33 illustrated in FIG. 19 is a table indicating messages corresponding to judgment results obtained by the first judgment unit 43, the second judgment unit 44, and the third judgment unit 45, and a message corresponding to the comprehensive determination result. The message table 33 includes fields such as processing details, judgment result, and message.

The processing details field indicates resolution, memory access, the number of operations, and comprehensive determination result. The judgment result field indicates a judgment result with respect to each of the processing details. The judgment result is represented by “0”, “1”, or “*”. The message field indicates messages corresponding to three kinds of judgment results with respect to each of the processing details.

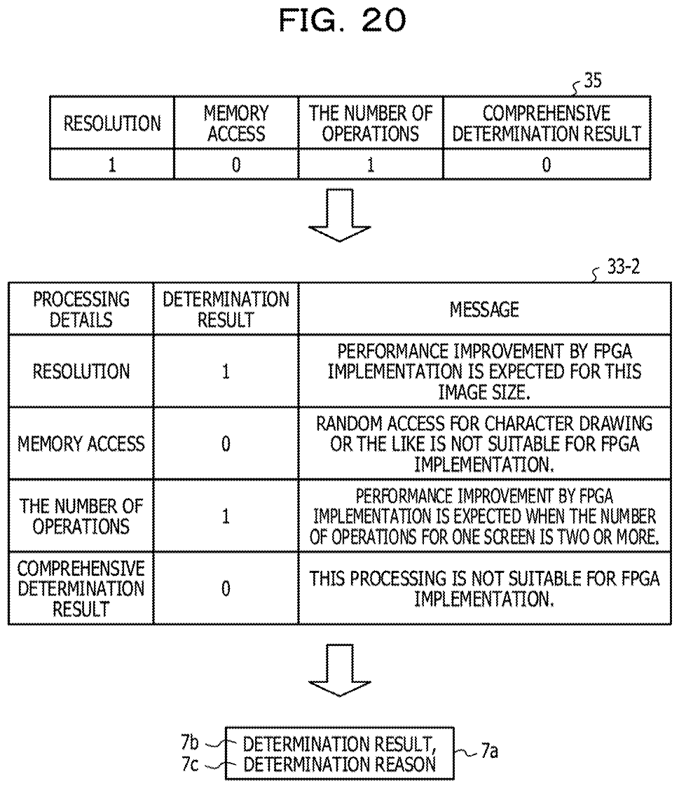

FIG. 20 is a diagram for explaining processing for generating a reply by the reply generating unit. In FIG. 20, it is assumed that the first judgment unit 43, the second judgment unit 44, and the third judgment unit 45 obtain “1” (suitable for FPGA) for resolution, “0” (unsuitable for FPGA) for memory access, and “1” (suitable for FPGA) for the number of operations, as indicated in the judgment data 35.

The reply generating unit 46 uses these values and refers to the correspondence table 32 (FIG. 18), and as a result, the reply generating unit 46 obtains the comprehensive determination result indicating “0” and records the comprehensive determination result in the judgment data 35. The reply generating unit 46 uses the judgment data 35 indicating the four judgment results and refers to the message table 33 (FIG. 19), and as a result, the reply generating unit 46 extracts messages for the respective judgment results and stores extracted messages 33-2 in the storage section 130.

The extracted messages 33-2 include: a message corresponding to the judgment result “1” for resolution “Performance improvement by FPGA implementation is expected for this image size”, a message corresponding to the judgment result “0” for memory access “Random access for character drawing or the like is not suitable for FPGA implementation”, a message corresponding to the judgment result “1” for the number of operations “Performance improvement by FPGA implementation is expected when the number of operations for one screen is two or more”, and a message corresponding to the judgment result “0” for comprehensive determination result “This processing is not suitable for FPGA implementation”.

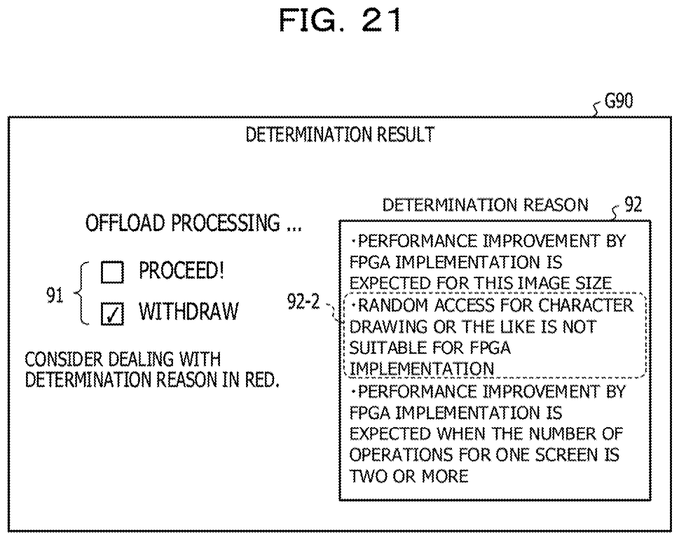

The reply generating unit 46 uses the message corresponding to the judgment result “0” for comprehensive determination result as the determination result 7b, the message corresponding to the judgment result “1” for resolution, the message corresponding to the judgment result “0” for memory access, and the message corresponding to the judgment result “1” for the number of operations as the determination reason 7c, and accordingly, the reply generating unit 46 generates the reply 7a and sends the reply 7a to the terminal 5. The terminal 5 displays at the user I/F 216 a determination result screen G90 (FIG. 21) based on the received reply 7a.

FIG. 21 illustrates an example of the determination result screen. The determination result screen G90 illustrated in FIG. 21 includes, for example, a judgment message 91 indicating the comprehensive determination result and a determination reason 92.

In the judgment message 91, when FPGA offload is suitable, a check mark is displayed for a message “Proceed!”; when FPGA offload is unsuitable, a check mark is displayed for a message “Withdraw”.

In the determination reason 92, three messages extracted from the message table 33 by the reply generating unit 46 are displayed. When the determination reason 92 includes a reason for determining that FPGA offload is unsuitable, the reason may be displayed in an emphasized manner with an emphasized display 92-2 to notify the user. When characters are displayed in red color of the emphasized display 92-2, a message 93 such as “Consider dealing with the determination reason in red.” may be displayed to suggest consideration to the user.

As described above, since with this embodiment the source code is not required to be analyzed like existing technologies, it is possible to promptly provide a determination result indicating that FPGA offload is suitable or unsuitable. As a result, when the user does not have enough knowledge and skill regarding FPGA offload, the user is able to accurately and promptly obtain a determination result by only configuring settings at the input screen G80. Furthermore, Since the determination result screen G90 provides the determination reason 92, it is possible to grasp the things required to be considered.

Moreover, there is no concern that the source code or processing details under development are leaked to outsiders, and thus, the user, without concern, is able to submit a request for determining the suitability for FPGA offload. It is possible to safely and easily use the present embodiment by users for development objects.

In the embodiment described above, the FPGA is a programable integrated circuit and the CPU is an integrated circuit with a fixed circuit configuration. The request receiving unit 42 is an example of a reception unit and the reply generating unit 46 is an example of a determination unit.

The present disclosure is not limited to the embodiment specifically disclosed and various modifications and various changes may be made without departing from the scope of the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process for determining FPGA implementation, the process comprising:
receiving operation information for determining whether to perform offload processing from a first integrated circuit of a fixed circuit configuration to a second integrated circuit of a programmable circuit configuration;
performing first judgment processing of determining that the offload processing is possible when resolution is equal to or higher than a threshold of suitability for the offload processing, the resolution being of an image targeted for an operation and being obtained from the operation information;
performing second judgment processing of determining that the offload processing is possible when it is determined in accordance with the operation information that access to a memory included in the second integrated circuit is continuous in the operation;
performing third judgment processing of determining that the offload processing is possible when it is determined in accordance with the operation information that the operation is able to be performed in a parallelized manner; and
performing determination processing of determining whether the offload processing is possible or impossible in accordance with a combination of a positive or negative judgment obtained in the first judgment processing, a positive or negative judgment obtained in the second judgment processing, and a positive or negative judgment obtained in the third judgment processing and outputting a determination result to a storage section.

2. The non-transitory computer-readable recording medium according to claim 1, wherein
the operation information contains information for specifying a first product of the first integrated circuit and information for specifying a second product of the second integrated circuit, and
in the first judgment processing, by referring to a database that is stored in the storage section and that indicates performances of different products with respect to a plurality of resolutions, a performance of the first product and a performance of the second product are compared to each other with respect to each of the plurality of resolutions; a lowest resolution is accordingly specified among particular resolutions of the plurality of resolutions, the particular resolutions being resolutions with which the performance of the second product is equal to or higher than the performance of the first product; and the lowest resolution is set as the threshold.

3. The non-transitory computer-readable recording medium according to claim 1, wherein
in the second judgment processing, when the operation information indicates that no drawing is added to the image, it is determined that the access to the memory included in the second integrated circuit is continuous.

4. The non-transitory computer-readable recording medium according to claim 1, wherein
in the third judgment processing, when the operation information indicates that it is possible to start the operation in a case in which not entire data of the image exists in the memory, it is determined that the operation is able to be performed in a parallelized manner.

5. The non-transitory computer-readable recording medium according to claim 1, wherein
when in the first judgment processing it is determined that the offload processing is possible, when in one of the second judgment processing and the third judgment processing it is determined that whether the offload processing is possible is unknown, and when in another of the second judgment processing and the third judgment processing it is determined that the offload processing is impossible, in the determination processing it is determined that the offload processing is possible.

6. The non-transitory computer-readable recording medium according to claim 1, wherein
when in the first judgment processing it is determined that whether the offload processing is possible is unknown, in the determination processing it is determined that the offload processing is impossible.

7. The non-transitory computer-readable recording medium according to claim 1, wherein
after whether the offload processing is possible or impossible is determined in the first judgment processing, the second judgment processing, and the third judgment processing, when it is determined, in the first judgment processing, the second judgment processing or the third judgment processing or any combination thereof, that the offload processing is impossible, in the determination processing it is determined that the offload processing is impossible.

8. The non-transitory computer-readable recording medium according to claim 1, wherein
in the determination processing, messages are obtained and a screen based on the messages is displayed at a display circuit, the messages being stored in the storage section and associated individually with a judgment result obtained in the first judgment processing, a judgment result obtained in the second judgment processing, a judgment result obtained in the third judgment processing, and the determination result obtained in the determination processing.

9. A method for determining FPGA implementation comprising:
receiving, by a computer, operation information for determining whether to perform offload processing from a first integrated circuit of a fixed circuit configuration to a second integrated circuit of a programmable circuit configuration;
performing first judgment processing of determining that the offload processing is possible when resolution is equal to or higher than a threshold of suitability for the offload processing, the resolution being of an image targeted for an operation and being obtained from the operation information;
performing second judgment processing of determining that the offload processing is possible when it is determined in accordance with the operation information that access to a memory included in the second integrated circuit is continuous in the operation;
performing third judgment processing of determining that the offload processing is possible when it is determined in accordance with the operation information that the operation is able to be performed in a parallelized manner; and
performing determination processing of determining whether the offload processing is possible or impossible in accordance with a combination of a positive or negative judgment obtained in the first judgment processing, a positive or negative judgment obtained in the second judgment processing, and a positive or negative judgment obtained in the third judgment processing and outputting a determination result to a storage section.

10. An information processing apparatus comprising:
a memory; and
a processor coupled to the memory and configured to:
receive operation information for determining whether to perform offload processing from a first integrated circuit of a fixed circuit configuration to a second integrated circuit of a programmable circuit configuration;
first-determine that the offload processing is possible when resolution is equal to or higher than a threshold of suitability for the offload processing, the resolution being of an image targeted for an operation and being obtained from the operation information;
second-determine that the offload processing is possible when it is determined in accordance with the operation information that access to a memory included in the second integrated circuit is continuous in the operation;
third-determine that the offload processing is possible when it is determined in accordance with the operation information that the operation is able to be performed in a parallelized manner; and
determine whether the offload processing is possible or impossible in accordance with a combination of a positive or negative judgment obtained by a first determination, a positive or negative judgment obtained by a second determination, and a positive or negative judgment obtained by a third determination and output a determination result to a storage section.
